(19) United States
(12) Patent Application Publication
(10) Pub. No.: US 2026/0127003 A1
(43) Pub. Date: May 7, 2026

(54) DEFINING AND INCORPORATING REUSABLE AGGREGATE COMPONENTS IN DATA PIPELINES

(71) Applicant: Matillion Limited, Salford (GB)

(72) Inventors: Ian Clive Funnell, Leeds (GB); Shane Paul Darren Booth, Manchester (GB)

(21) Appl. No.: 18/935,334

(22) Filed: Nov. 1, 2024

(51) Int. Cl. G06F 9/38

(52) U.S. Cl. CPC G06F 9/3867; G06F 9/3836

(57) ABSTRACT

A data pipeline orchestration tool facilitates the creation of re-useable aggregate components that can be created during building of new data pipelines or integrated into existing data pipelines and manages the placement and connection of aggregate components within an existing pipeline. The aggregate components utilize virtual components as connectors to other data pipeline components, which include a virtual source and/or a virtual sink. The virtual source maps a specific schema of a source of data to be processed by the aggregate component, such as specific fields of a database table, with a generic schema of the virtual source. The virtual sink designates the flow of data from the aggregate component to one or more downstream components of the data pipeline. Aggregate components can also be stored in a component library or other component storage offered by the data pipeline orchestration tool to facilitate reuse of aggregate components across data pipelines.

### BACKGROUND

The disclosure generally relates to digital data processing and information retrieval (e.g., CPC subclass G06F/00) and ETL procedures (e.g., CPC subclass CPC G06F/254).

ETL (extract, transform, load) is a data integration process that was introduced in the 1970s. The ETL process extracts data from multiple data sources, cleans and organizes (i.e., transforms) the extracted data for the intended use and/or target system, and loads the transformed data into a target system (e.g., data warehouse or data lake). ELT (extract, load, transform) is a similar data integration process that defers transformation until after the extracted raw data has been loaded into the target system.

The rise of cloud computing has introduced “ETL pipelines” or “data pipelines.” ETL pipeline refers to the implementations or collection of processes and tools for ETL in a cloud computing environment that involves not only multiple data sources but heterogeneous data sources. In some cases, “cloud ETL” or “cloud ELT” is used instead of data pipeline. While “data pipeline” and “ETL pipeline” are sometimes used interchangeably, some use “data pipeline” to refer more specifically to a data integration process that includes streaming data sources or “real-time” data sources. However, it is more common for data pipelines to refer to the processes and tools that collectively implement ETL regardless of the data sources being streamed or “real-time” data sources. “Data pipeline” suggests the flow of data over a pipeline from sources, through a series of processing steps or components that implement the processing steps, to a destination or sink.

### BRIEF DESCRIPTION OF THE DRAWINGS

Embodiments of the disclosure may be better understood by referencing the accompanying drawings.

FIG. 1 is a conceptual diagram of integrating an aggregate component into a data pipeline being built.

FIG. 2 is a conceptual diagram depicting the creation of a reuseable aggregate component.

FIG. 3 is a flowchart of example operations for incorporating an aggregate component into a data pipeline.

FIG. 4 is an example of operations to build an aggregate component using generic data pipeline components from a library of generic components.

FIG. 5 is an example of operations for building an aggregate component using data pipeline components from an existing data pipeline.

FIG. 6 depicts an example computer system with an aggregate component manager.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

This description uses the term “aggregate component” to refer to a collection of components of a data pipeline. The aggregate component comprises one or more data pipeline components that perform respective operations for ELT/ETL. Data pipeline components included in an aggregate component can perform but are not limited to aggregation transformations, as aggregate components can comprise any types of data pipeline components offered by a data pipeline orchestration platform.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Data pipeline orchestration tools have been integrated into software developer workflows to increase their productivity and efficiency. These data pipeline orchestration tools allow developers to abstract the logic of languages used as part of data pipeline creation, like structured query language (SQL) into a graphical user interface (GUI) depiction and simplify ELT/ETL creation for end users. However, these abstractions of lower-level languages, such as SQL, have constrained developers to work within specific schemas of their databases, making it difficult to re-use generic data transformation logic across multiple data pipelines.

Disclosed herein is a data pipeline orchestration tool that facilitates the creation of re-useable aggregate components that can be created during building of new data pipelines or integrated into existing data pipelines. With this data pipeline orchestration tool, these aggregate components can be placed within a data pipeline and connected to the logic therein. To accomplish this connection, these aggregate components utilize virtual components as connectors to other components of data pipelines, which include a virtual source and/or a virtual sink. The virtual source maps a specific schema of a source of data to be processed by the aggregate component, such as specific fields of a database table, with a generic schema of the virtual source. The virtual sink designates the flow of data from the aggregate component to one or more downstream components of the data pipeline. With these aggregate components, a data orchestration tool can increase developer productivity by creating reuseable logic and increase the flexibility of the data pipeline orchestration tool as a whole by providing a wider range of functionality. Aggregate components may also be stored in a component library or other component storage offered by the data pipeline orchestration tool to facilitate reuse of aggregate components across data pipelines.

### Example Illustrations

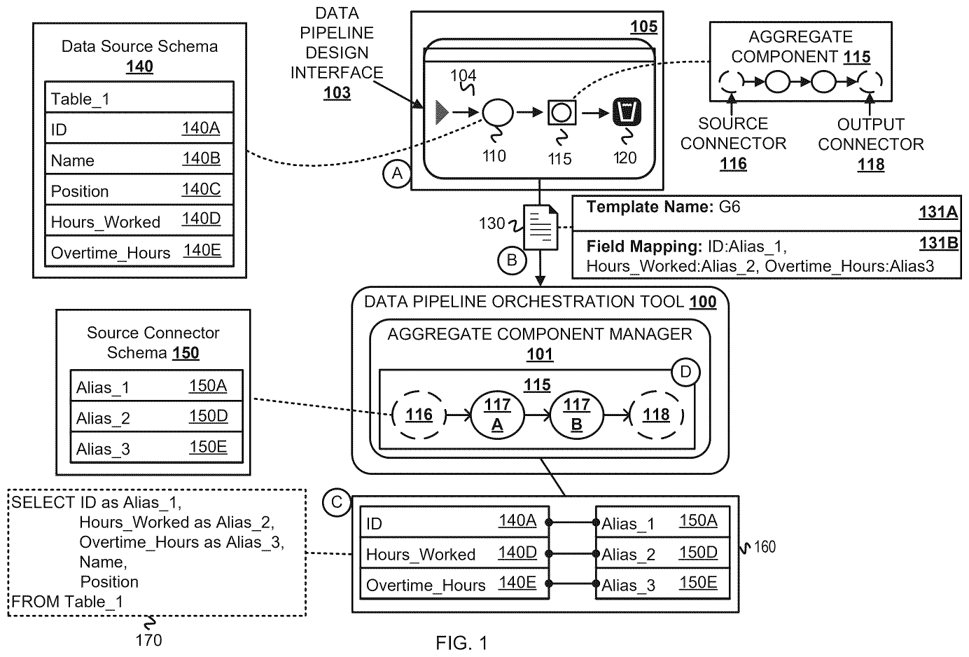

FIG. 1 is a conceptual diagram of integrating an aggregate component into a data pipeline being built. FIG. 1 depicts a data pipeline design interface (“design interface”) 103 presented via a GUI 105. A data pipeline orchestration tool 100 manages configuration and execution of data pipelines built via the design interface 103. The data pipeline orchestration tool 100 comprises an aggregate component manager 101. The aggregate component manager 101 manages the creation of aggregate components and integration of aggregate components into data pipelines.

FIG. 1 is annotated with a series of letters A-C, representing the stages for incorporating an aggregate component into an existing data pipeline. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, an aggregate component 115 is inserted into a data pipeline 104 being built via the design interface 103. The data pipeline 104 comprises a plurality of components: a data source 110, the aggregate component 115, and a data sink 120. During this stage, respective arrow GUI elements are drawn between the data source 110 and the aggregate component 115 as well as between the aggregate component 115 and the data sink 120, which integrates the aggregate component into the data pipeline 104.

At stage B, the aggregate component manager 101 obtains a configuration 130 of the aggregate component 115. For instance, the configuration 130 can comprise data provided as input by a user designing the data pipeline 104 via the design interface 103. This configuration has two fields, a field 131A and a field 131B. The field 131A stores a unique identifier for the aggregate component 115, and the field 131B stores alias names to assign to fields in the data source schema 140. In this example, the field 131A, bearing the unique identifier of the aggregate component 115, is marked “G6.” This example depicts a configuration which will be used to achieve the mapping between the schema of the data source 110 and the “generic” schema of the aggregate component 115 as will be described below. The configuration 130 depicted in FIG. 1 comprises the following:

### Template Name: G6

### Field Mapping: ID: Alias_1, Hours_Worked: Alias_2, Overtime_Hours: Alias3

At stage C, the aggregate component manager 101 configures a connection between the data source 110 and the aggregate component 115 via the source connector 116. Using the field mappings indicated in the field 131B, the aggregate component manager 101 maps the relevant subset of the data source schema 140 to the source connector schema 150, where the relevant subset is the fields of the data source schema designated in the field 131B. FIG. 1 depicts bindings 160 that illustrate the mapping of the field names as an abstraction of the underlying SQL code. Elements 140A, 140D, and 140E, representing the fields “ID”, “Hours_Worked”, and “Overtime_Hours”, respectively, are bound to elements 150A, 150D, and 150E, representing the aliased field names of the source connector schema 150. The aggregate component manager 101 generates a SQL statement 170 when this mapping is made that binds the fields to respective aliases. For instance, to generate SQL statements, the aggregate component manager 101 can be configured with a template for a SQL SELECT statement that maps data source schemas to a schema of a source connector of an aggregate component and populates this template based on values identified in configuration data obtained upon insertion of an aggregate component into a data pipeline. For data fields of the data source indicated in the data source schema 140 that are not identified in the configuration 130, or elements 140B and 140C representing the fields “Name” and “Position”, respectively, the aggregate component manager 101 can insert the field names directly in the SQL statement 170 without aliases since the data from these fields will not be directly transformed by the aggregate component 115 at runtime. To illustrate, the SQL statement 170 generated in this example is:

```
“SELECT ID as Alias_1,
  Hours_Worked as Alias_2,
  Overtime_Hours as Alias_3,
  Name,
  Position
FROM Table_1”
```

In this example, the aggregate component manager 101 can populate a SQL SELECT statement template with the values of the field 131B and an indication of a data source to which these fields correspond (i.e., the data source 110 in this example). The SQL statement 170 is later executed at runtime of the data pipeline 104.

At stage D, the aggregate component manager 101 connects the output connector 118 to the data sink 120. The output connector 118 acts as an “end success” orchestration component rather than executing any program code for ELT/ETL, signaling a completion of execution of components of aggregate component 115. The output connector 118 can be assigned a name or identifier by the aggregate component manager 101 since aggregate components can comprise more than one output connector in an aggregate component, as this allows for differentiation of output connectors by the pipeline orchestration tool 100. A name/identifier of the output connector 118 can thus be associated with the connection of the output connector 118 to the data sink 120. At runtime, the output connector 118 passes its input to the data sink 120 without performing any transformation of the data input thereto.

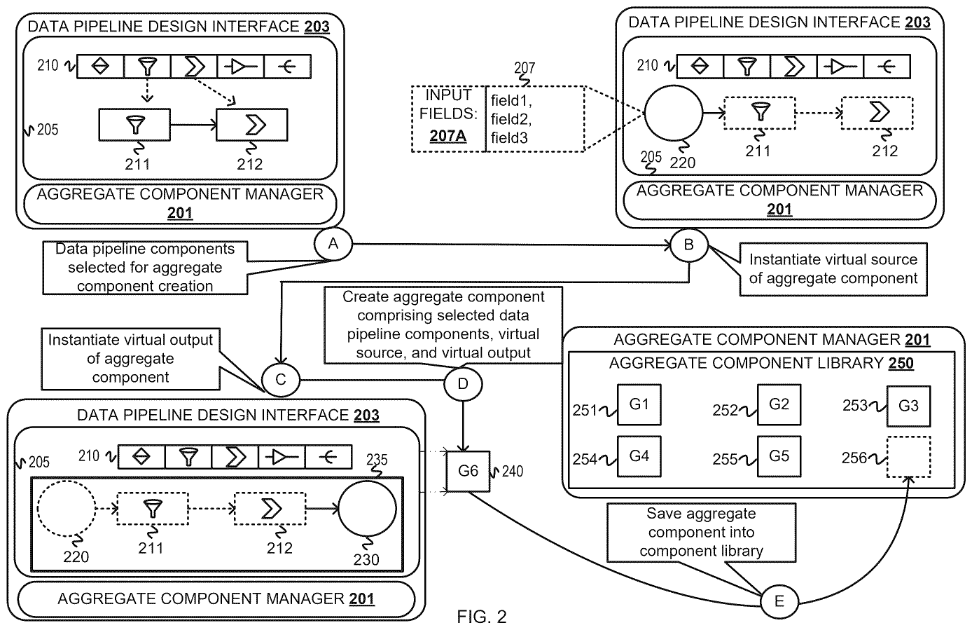

FIG. 2 is a conceptual diagram depicting the creation of a reuseable aggregate component. As depicted in FIG. 2, aggregate components can be created and saved in a library for later use. FIG. 2 depicts an aggregate component manager 201 in this example as executing as part of a data pipeline design interface (“design interface”) 203. Similar to the aggregate component manager 101 of FIG. 1, the aggregate component manager 201 manages creation and storage of aggregate components by end users of the design interface 203. For instance, the aggregate component manager 201 can be implemented as a widget of the data pipeline design interface 203.

FIG. 2 is annotated with a series of letters A-E representing stages of operations. Each stage represents one or more operations. Each letter corresponds to one or a multitude of operations taken at each step. Although these stages are ordered for this example, the stages illustrate one example to aid in understanding this disclosure and should not be used to limit the claims. Subject matter falling within the scope of the claims can vary from what is illustrated.

At stage A, GUI elements representing distinct respective data pipeline components are selected for incorporation into an aggregate component. These GUI elements can be selected and dragged onto the GUI of the design interface 203. The GUI elements representing respective data pipeline components are hereinafter referred to as “the component 211” and “the component 212.” An arrow is additionally dragged between the first component 211 and the second component 212, linking the components 211, 212 such that the output of the first component 211 is passed as input of the second component 212. Each of these components 211, 212 will perform an operation for ELT/ETL (e.g., a data transformation operation) on the incoming data during the execution of the data pipeline in which these components 211, 212 are incorporated.

At stage B, the aggregate component manager 101 instantiates a source connector of the aggregate component. A GUI element representing a source connector (“source connector 220” for simplicity) is selected and added to the pipeline orchestration interface 205. The configuration of the source connector 220 is shown in element 207, comprised of a field 207A, labeled “INPUT FIELDS.” The field 207A indicates a number of data fields for which data will be provided as input to the aggregate component being created when the aggregate component is integrated into a data pipeline and executed. This example depicts the field 207A as comprising three field names, named “field1”, “field2”, and “field3”. These will be later used as aliases to which to bind actual data field names as described above in reference to FIG. 1. Once the configuration for the source connector 220 has been completed (e.g., via input to the design interface 203), an arrow is drawn between the source connector 220 and the component 211, illustrating that the output of the source connector 220 will be sent to the input of the component 211.

At stage C, a GUI element representing an output connector (“output connector 230”) is added to the design interface 203. The output connector 230 is then connected to the component 212, illustrating that the output of the component 212 is passed to the output connector 230.

At stage D, an aggregate component 235 comprising the source connector 220, the component 211, the component 212, and the output connector 230 is indicated for saving. This can be done within the design interface 203 by selecting a GUI element. The aggregate component 235 is stored as a single component that implements the functionality of the components of which it is comprised. The aggregate component 235 can be given an identifier or icon to virtually distinguish the aggregate component 235 from other aggregate components. In this illustration, the aggregate component 235 is assigned an identifier “G6.”

At stage E, the aggregate component 235 is saved into a library 250 of aggregate components. In this example, aggregate components 251, 252, 253, 254, and 255 are already maintained in the library 250, which is managed by the aggregate component manager 101. Upon saving the aggregate component 235 in the library 250, and the aggregate component 235 can be integrated into new and existing pipelines.

FIG. 2 depicts an example in which a source connector and an output connector are selected via a GUI and added to an aggregate component as part of building the aggregate component. In implementations, instantiation of source connectors and output connectors can be managed by the aggregate component manager 101. For instance, upon obtaining a request to store an aggregate component comprising the components 211, 212, the aggregate component manager 101 can instantiate the source connector 220 and the output connector 230 and orchestrate connection of the source connector 220 to the component 211 and of the component 212 to the output connector 230. The request indicating the selected components should also indicate a number of data fields, if any, from which the aggregate component will obtain data as input reflected in a schema of the aggregate component input represented in a configuration of the source connector.

FIG. 1 and FIG. 2 illustrate a case where an aggregate component has a single source connector and single output connector. In implementations, aggregate components can have varying configurations of virtual sources and/or virtual outputs. For instance, an aggregate component can have no source connector and one output connector. In this case, no source connector is instantiated for the aggregate component, and transformation logic within the aggregate component is performed on a view or an inline SELECT. As another example, an aggregate component can have one source connector and no output connectors. In this case, no output connector is instantiated for the aggregate component. This case is useful when a target dataset in which data processed by a data pipeline are ultimately loaded can be populated in different ways from different sources. As yet another example, an aggregate component can have multiple output connectors with or without a source connector. In this case, more than one output connector is instantiated in the aggregate component. The output connectors can be configured to retrieve data from intermediary or components from within the aggregate component, with each output connector providing its output to a different data sink. The configuration of each output connector can include a unique identifier or name which can be used to differentiate between each output connector when the output connectors are connected to their respective data sinks.

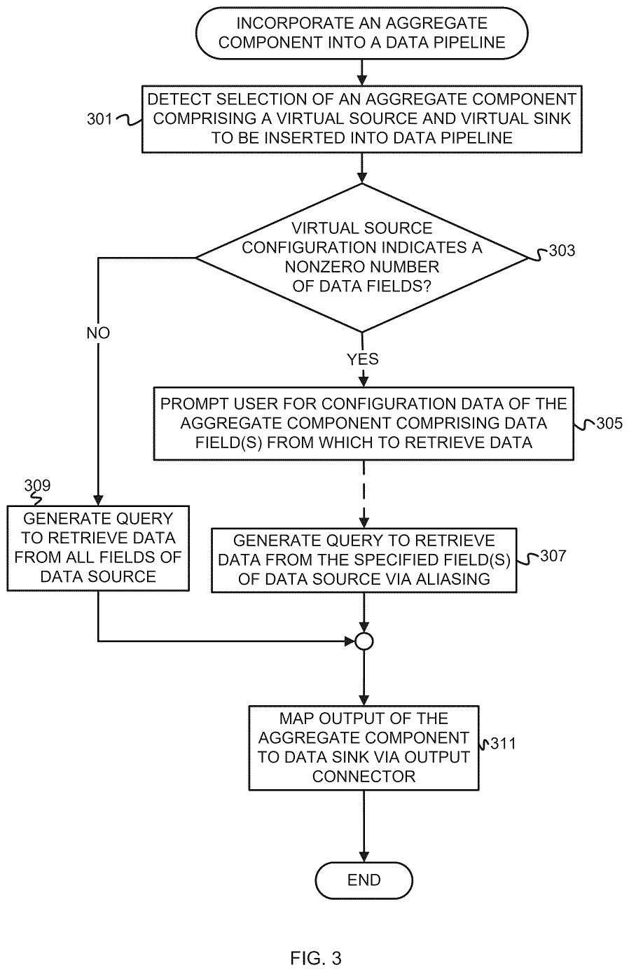

FIGS. 3-5 are flowcharts of example operations. The example operations are described with reference to an aggregate component manager for consistency with the earlier figure and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The example operations refer to a “virtual source” and “virtual sink.” These terms can be used interchangeably with the “source connector” and “output connector” described above. The virtual source and virtual sink are referred to as “virtual” because the respective components facilitate integration of an aggregate component into a data pipeline rather than performing ELT/ETL operations.

FIG. 3 is a flowchart of example operations for incorporating an aggregate component into a data pipeline. Incorporating an aggregate component(s) into a new or existing data pipeline facilitates the reuse of sequences of data pipeline components that are commonly used across multiple data pipelines, thereby reducing development time that would generally be spent re-creating the same sequence of pipeline components across multiple pipelines. The example operations of FIG. 3 presume an aggregate component has already been created and saved into a library of aggregate components.

At block 301, the aggregate component manager detects the selection of an aggregate component comprising a virtual source and a virtual sink to be inserted into a data pipeline. For instance, the aggregate component manager may detect the selection of the aggregate component via placement of the aggregate component within a GUI of the pipeline orchestration tool, such as based on selection of the aggregate component from a library of aggregate components. From a user perspective, the aggregate component is positioned within the GUI of the data pipeline creation interface, represented as a single icon. The icon representation of the aggregate component is an abstraction of the functionality of the aggregate component as a whole. Subsequent example operations assume that the aggregate component has a single virtual source and a single virtual output.

At block 303, the aggregate component manager determines if a configuration of the virtual source of the aggregate component indicates a nonzero number of data fields. The pipeline orchestration tool can analyze the configuration of the virtual source of the aggregate component to determine an expected number of data fields (e.g., a number of columns of a designated table) corresponding to a preceding component of the data pipeline (if any) or other input, such as a default table, from which the virtual source is to retrieve data. The aggregate component may expect a certain number of fields of a data source from which data should be sourced at runtime or may simply retrieve data from all fields of the data source. In the latter case, the configuration of the virtual source will not specify a number of data fields. The virtual source configuration may be maintained by the aggregate component manager and retrieved based on selection of the aggregate component (e.g., based on an identifier of the selected aggregate component) or may be associated with the aggregate component as metadata that was obtained when the aggregate component selection is detected at block 301. If the virtual source configuration indicates a nonzero number of data fields, operations continue at block 305. Otherwise, operations continue at block 309.

At block 305, the aggregate component manager prompts a user for configuration data of the aggregate component comprising one or more data fields from which to retrieve data. Configuration data for which the aggregate component manager prompts the user can comprise of the selection of a data source and the fields in that data source schema which will be bound to the virtual source schema. The selection of a data source may be automatically populated when a connection is drawn via the design interface between an upstream component and the aggregate component. When this connection is made, a window prompting the user for the configuration of the fields may be shown via the GUI. The prompt to the user will indicate a number of data fields expected by the aggregate component for proper functioning, and a user will input which fields (e.g. column names) match to each expected field in the configuration. Expected fields may be represented with aliases or identifiers. For example, if the virtual source has been configured to retrieve data from three fields of a data source as input to the intermediate components of the aggregate component for processing (e.g., for data transformation implemented by the intermediate components), the configuration prompt to the user can contain three blank fields to fill in the names of those fields in the data source or three drop down menus that each have been populated with field names of the data source. In implementations, the aggregate component manager can prepopulate the configuration prompt with suggested values for presentation to the user. For instance, the aggregate component manager may determine the suggested values based on suggestions by an artificial intelligence (AI)-based agent that executes as part of the pipeline orchestration tool and monitors user selections for preceding data pipeline components. The transition from block 303 to block 305 is depicted with a dashed line to indicate that the aggregate component manager awaits input from a user of the pipeline creation tool before proceeding with the example operations.

At block 307, the aggregate component manager generates a query to retrieve data from the specified data field(s) of the designated data source via aliasing. This generated query maps one or more specific data fields from the data source, which are specified in the aggregate component configuration, to aliases defined for the virtual source based on the configuration of the virtual source. The configuration of the virtual source indicates one or more aliases to which data fields specified in a configuration obtained for the aggregate component are to be bound, such as via SQL aliasing. For instance, the aggregate component manager can generate a SQL SELECT statement that binds data fields “field1”, “field2”, . . . , “fieldN” to aliases defined in the virtual source configuration “alias1”, “alias2”, . . . , “aliasN” via a SQL query comprising the statement “SQL SELECT field1 AS alias 1, field2 AS alias2, . . . , fieldN AS aliasN.” For any additional fields of the data source not specified in the virtual source configuration, the aggregate component manager can include in the generated query (e.g., in the generated SQL SELECT statement) the field names directly without aliasing. The aggregate component manager also includes an indication of the data source in the generated query, such as with a SQL FROM statement indicating the table name specified in the configuration data obtained for the aggregate component.

At block 309, the aggregate component manager generates a query to retrieve data from all fields of the data source indicated in the aggregate component configuration. In implementations where the virtual source has zero fields of a data source specified (e.g., rather than some specific number of data fields), the aggregate component manager will retrieve data from all data fields from the designated data source without aliasing. For instance, the aggregate component manager can construct a SQL SELECT statement which will select all columns from the data source without any aliasing (i.e., with SQL SELECT *). During this operation, aliases such as SQL aliases will not be assigned to column names. The aggregate component creator also includes an indication of the data source in the generated query, such as with a SQL FROM statement indicating the table name specified in the configuration data obtained for the aggregate component.

At block 311, the aggregate component manager maps the output of the aggregate component via the virtual output to a defined data sink in the same way the data source was connected to the virtual source. In the GUI, an arrow is drawn by the user between the aggregate component and the virtual data sink, which configures the output of the aggregate component such that the output of the aggregate component is sent to the input of the data sink. The virtual output will generate aliases used for binding the output of the aggregate component to the input of the data sink. Data from any non-aliased columns ingested by the virtual source may pass through the aggregate component and to the data sink via the virtual output without aliasing of the respective columns since these columns were not aliased on intake.

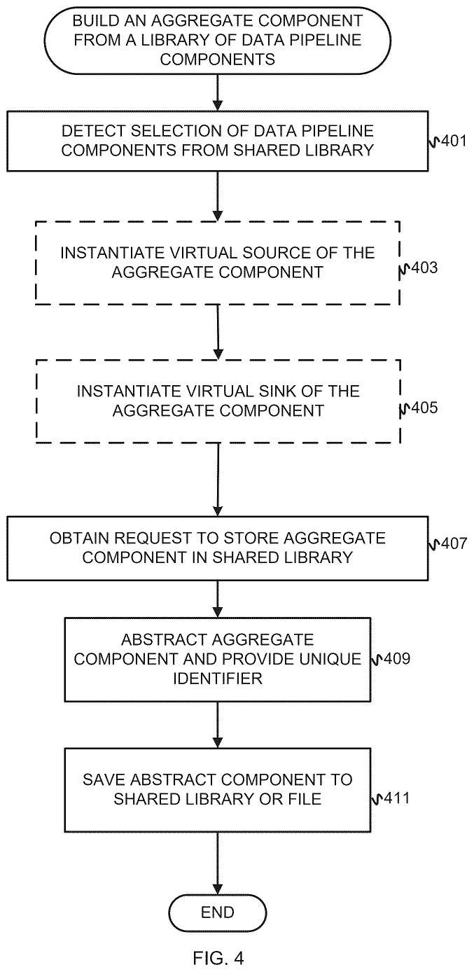

FIG. 4 is an example of operations to build an aggregate component using generic data pipeline components from a library of generic components. Creating an aggregate component from a library of components is useful to a user of a data pipeline orchestration tool because this allows for the re-use of collections of generic components that perform common transformations on a dataset(s). The operations in FIG. 4 presume that a library of generic components is available to the data pipeline orchestration tool. The example operations depict blocks 403 and 405 with dashed lines to indicate that these operations are optional to reflect the flexibility in options for building an aggregate component. For instance, an aggregate component can include a single virtual source with no virtual output, a single virtual output with no virtual source, or one or more virtual outputs with or without a data source. In between the virtual source and virtual output of an aggregate component, the aggregate component can comprise any number of data pipeline components (i.e., zero or more components), which can be connected in any order to perform a data transformation(s).

At block 401, the aggregate component manager detects the selection of data pipeline components inside the design interface of a data pipeline orchestration tool. The selection of components represents a sequence of data transformations on a data set provided by a data source. The selection of components, being arranged in the design interface, are linked within the GUI via a drag and drop connector (i.e. an arrow), dictating the flow of the data transformation.

At block 403, the aggregate component manager instantiates a virtual source within the design interface of the data pipeline orchestration tool. The aggregate comment manager instantiates the virtual source based on selection of the virtual source by the user or based on receipt of a command (e.g., from user input) to create a virtual source for the aggregate component. The virtual source is connected to the first data pipeline component in the transformation path such that the input of the first data pipeline component receives the output of the virtual source. The virtual source component's configuration specifies an expected number of fields (e.g., unique columns from a data source), if any, from which data should be retrieved for the first data pipeline component within the aggregate component to perform its operation. The expected number of fields may be represented with a number of aliases to which actual data fields will be mapped later when the aggregate component is integrated into a data pipeline. The configuration of the virtual source can also indicate a default data source and may further identify one or more columns of the data source so that the aggregate component in which it is included can be executed independently of a data pipeline, such as for testing purposes. A virtual source may not be instantiated for the aggregate component if the aggregate component will generally be the first component of a data pipeline in which it is inserted.

At block 405, the aggregate component manager instantiates a virtual sink of the aggregate component. The aggregate comment manager instantiates the virtual sink based on selection of the virtual sink by the user or based on receipt of a command (e.g., from user input) to create a virtual output for the aggregate component. The virtual sink is connected to the final data pipeline component in the transformation path such that the input of the virtual sink receives the output of the final data pipeline component selected for aggregate component creation. A virtual sink may not be instantiated for the aggregate component if the aggregate component will generally be the last of a data pipeline in which it is inserted.

At block 407, the aggregate component manager obtains a request to store the aggregate component into a shared library of aggregate components. This request can trigger via the GUI via a button or other GUI element press.

At block 409, the aggregate component manager assigns the aggregate component a unique identifier. This identifier may comprise text received as user input. For instance, this identifier can be used as a descriptive label to generally identify it amongst other aggregate components when determining transformations to be performed. For example, an aggregate component with data pipeline components that performs a sequence of data verification on user metadata could be labeled “User Metadata Verification Pipeline.” The identifier can also be generically assigned to an aggregate component by the aggregate component manager instead of being provided a descriptive identifier. The aggregate component is abstracted to a single component comprising the virtual source, the selected pipeline components, and a virtual output.

At block 411, the aggregate component manager saves the abstracted component. The abstracted component can be saved into a shared library within the data pipeline orchestration tool, where it can be accessed by any user who has access to that shared library. Alternatively, the abstracted component can be saved into a file formatted such that said file could be transferred and shared with other users across different networks.

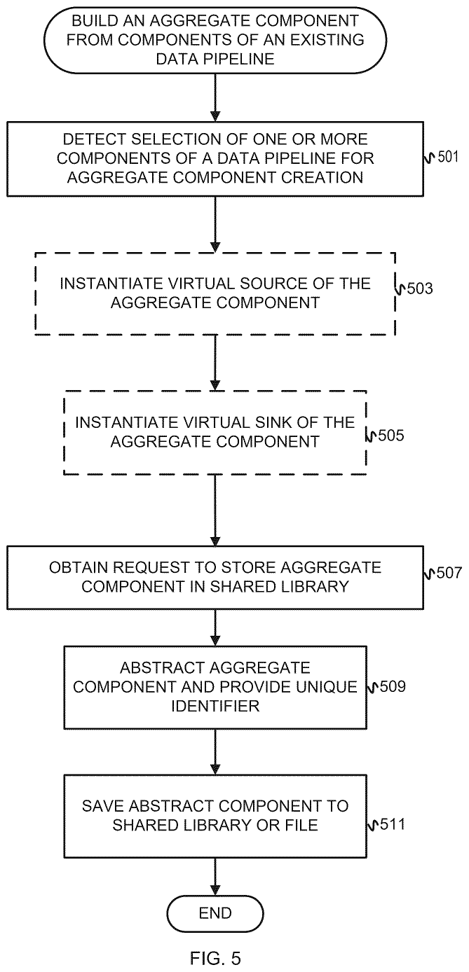

FIG. 5 is an example of operations for building an aggregate component using data pipeline components from an existing data pipeline. An existing data pipeline could be a data pipeline that has already been created or one in the process of being created within the data pipeline orchestration tool. Creating an aggregate component from existing data pipeline components allows for the re-useability of data transformation paths comprising components with complex configurations, saving development time from having to recreate complex transformations from scratch. The operations in FIG. 5 presume the creation of an aggregate component with a single virtual source, and a single virtual sink, and comprising one or more data pipeline components. Similar to FIG. 4, the example operations depict blocks 503 and 505 with dashed lines to indicate that these operations are optional to reflect the flexibility in options for building an aggregate component.

At block 501, the data pipeline orchestration tool detects selection of one or more data pipeline components for aggregate component creation. The selection of components represents a sequence of data transformation components of an existing data pipeline. The one or more components are selected via a GUI provided by a data pipeline orchestration tool. The data pipeline orchestration tool can create copies of the components and provide the copies of the components (while maintaining the connections between the components) to the aggregate component manager. In other examples, the aggregate component manager operates directly on the selected data pipeline components.

At block 503, the aggregate component manager instantiates a virtual source of the aggregate component. The aggregate comment manager instantiates the virtual source based on selection of the virtual source by the user or based on receipt of a command (e.g., from user input) to create a virtual source for the aggregate component. The virtual source component's configuration specifies an expected number of fields (e.g., unique columns from a data source) to be ingested for the first data pipeline component to perform its operation. For instance, the configuration of the virtual source component can specify the expected number of fields as aliased names. The configuration of the virtual source can also indicate a default data source and may further identify one or more columns of the data source so that the aggregate component in which it is included can be executed independently of a data pipeline, such as for testing purposes.

At block 505, the aggregate component manager instantiates a virtual sink of the aggregate component. The aggregate comment manager instantiates the virtual sink based on selection of the virtual output by the user or based on receipt of a command (e.g., from user input) to create a virtual sink for the aggregate component. The aggregate component can assign a unique identifier or name to the virtual sink so that virtual sinks in aggregate components with multiple virtual sinks can be distinguished from each other. The virtual sink comprises functionality to signal that operations of the aggregate component were completed successfully at runtime and to assign aliases to columns for which data were retrieved by the aggregate component (if any) and passed into the virtual source.

At block 507, the aggregate component manager obtains a request to store the aggregate component into a shared library of aggregate components. This request can trigger via the GUI via a button or other GUI element press.

At block 509, the aggregate component manager abstracts the aggregate component and assigns it a unique identifier. The process of abstracting the aggregate component is performed similarly described above in reference to FIG. 4 at block 409.

At block 511, the aggregate component manager saves the abstracted component. The abstracted component can be saved into a shared library within the data pipeline orchestration tool, where it can be accessed by any user who has access to that shared library. Alternatively, the abstracted component can be saved into a file formatted such that said file could be transferred and shared with other users across different networks.

### Variations

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

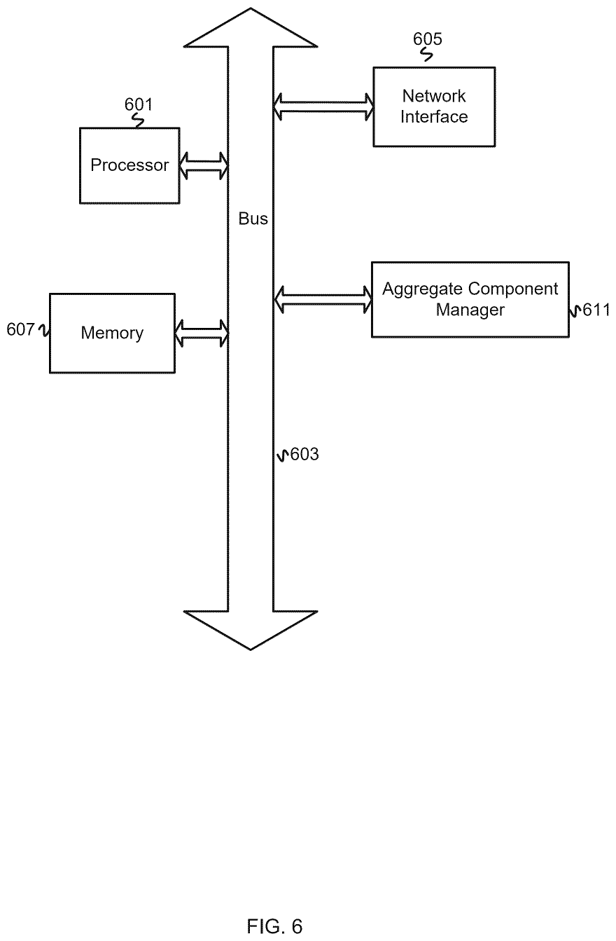

FIG. 6 depicts an example computer system with an aggregate component manager. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes an aggregate component manager 611. The aggregate component manager 611 facilitates the creation of aggregate components that can be re-used across data pipelines. The aggregate component manager 611 manages the connection of an aggregate component to a data source and/or a data sink of a data pipeline to integrate the aggregate component in the data pipeline. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
defining an aggregate component that is reusable across extract, transform, load (ETL) data pipelines or extract, load, transform (ELT) data pipelines, wherein the aggregate component comprises a plurality of data pipeline components, wherein defining the aggregate component comprises,
detecting selection of at least a first data pipeline component and second data pipeline component for inclusion in the aggregate component;
creating a first virtual component and connecting an output of the first virtual component to an input of the first data pipeline component;
configuring a schema of the first virtual component, wherein the schema of the first virtual component indicates a number of expected data fields from which to obtain data as input to the aggregate component; and
creating a second virtual component and connecting an output of the second data pipeline component to an input of the second virtual component, wherein the second virtual component binds an output of the second data pipeline component to a downstream data pipeline component; and
storing the aggregate component for incorporation into data pipelines.

2. The method of claim 1, further comprising inserting the aggregate component into a first data pipeline, wherein the first data pipeline comprises one or more data pipeline components.

3. The method of claim 2, further comprising obtaining a configuration of the aggregate component based on insertion of the aggregate component into the first data pipeline,
wherein the configuration of the aggregate component comprises an indication of a data source from which to source data for input to the first data pipeline component and one or more data fields of the data source,
wherein a number of the one or more data fields indicated in the configuration matches the number of expected data fields indicated in the schema of the first virtual component,
and wherein inserting the aggregate component into the first data pipeline comprises mapping the one or more data fields of the data source to respective ones of the expected data fields.

4. The method of claim 3, wherein the data source corresponds to a different data pipeline component of the one or more data pipeline components, wherein the different data pipeline component is upstream of the aggregate component in the first data pipeline.

5. The method of claim 3, wherein the number of data fields indicated in the configuration is all data fields of the data source and the configuration of the aggregate component indicates all data fields of the data source, and wherein inserting the aggregate component into the first data pipeline comprises generating a query to retrieve data from each data field of the data source as input to the first data pipeline component.

6. The method of claim 3,
wherein the number of expected data fields indicated in the configuration is one or more and the configuration of the aggregate component indicates one or more data fields of the data source, wherein the one or more data fields of the data source are a subset of all data fields of the data source,
and wherein inserting the aggregate component into the first data pipeline comprises generating a query that binds each of the one or more data fields of the data source to a respective alias and retrieves data from each of the one or more data fields as input to the first data pipeline component.

7. The method of claim 3,
wherein inserting the aggregate component into the first data pipeline comprises connecting the second virtual component to a different data pipeline component of the one or more data pipeline components,
wherein the different data pipeline component is downstream of the aggregate component in the first data pipeline,
and wherein connecting the second virtual component to the different data pipeline component comprises binding an output of the aggregate component to an input of the different data pipeline component via one or more aliases generated by the second virtual component.

8. The method of claim 1, wherein detecting selection of the first and second data pipeline components is based on detecting at least a first input into a graphical user interface (GUI) comprising the selection of the first and second data pipeline components.

9. The method of claim 1, wherein defining the aggregate component further comprises configuring the aggregate component with a default data source indicated in an obtained configuration of the aggregate component, wherein the obtained configuration indicates the default data source and one or more data fields of the default data source, wherein the one or more, wherein the one or more data fields of the default data source matches the number of expected data fields.

10. The method of claim 1, wherein storing the aggregate component comprises storing the aggregate component in a library of data pipeline components for building data pipelines.

11. One or more non-transitory machine-readable media having program code stored thereon, the program code comprising instructions to:
detect selection of a plurality of data pipeline components for inclusion in an aggregate data pipeline component, wherein the plurality of data pipeline components comprises an upstream data pipeline component and a downstream data pipeline component;
create a virtual source component of the aggregate data pipeline component, wherein the instructions to create the virtual source component comprise instructions to, instantiate the virtual source component;
connect an output of the virtual source component to an input of the upstream data pipeline component; and
generate a configuration of the virtual source component based on configuration of a schema of the virtual source component, wherein the configuration of the virtual source component indicates an expected number of columns from which to obtain data as input to the virtual source component;
create a virtual sink component of the aggregate data pipeline component, wherein the instructions to create the virtual sink component comprise instructions to, instantiate the virtual sink component; and
connect an output of the downstream data pipeline component to an input of the virtual sink component; and
store the aggregate data pipeline component for incorporation into one or more data pipelines, wherein the one or more data pipelines are extract, transform, load (ETL) data pipelines or extract, load, transform (ELT) data pipelines.

12. The non-transitory machine-readable media of claim 11,
wherein the program code further comprises instructions to insert the aggregate data pipeline component into a first data pipeline,
wherein the instructions to insert the aggregate data pipeline component into the first data pipeline comprise instructions to,
obtain a configuration of the aggregate data pipeline component indicating a table from which to retrieve data as input and one or more columns of the table, wherein a number of the one or more columns matches the expected number of columns; and
for each of the one or more columns of the table, map the column to an indication of an expected column from which to obtain data as input to the virtual source component.

13. The non-transitory machine-readable media of claim 12, wherein the instructions to insert the aggregate data pipeline component into the first data pipeline comprise instructions to,
based on a determination that the configuration of the aggregate data pipeline component indicates all columns of the table, generate a query to retrieve data from each column of the table; and
based on a determination that the configuration of the aggregate data pipeline component indicates a subset of columns of the table, generate a query that binds each of the subset of columns to a respective alias and retrieves data from each of the subset of columns and retrieves data from others of the columns of the table without aliases.

14. The non-transitory machine-readable media of claim 11, wherein the instructions to detect selection of the plurality of data pipeline components comprise instructions to detect at least a first input into a graphical user interface (GUI) comprising the selection of the plurality of data pipeline components.

15. An apparatus comprising:
a processor; and
a machine-readable medium having instructions stored thereon that are executable by the processor to cause the apparatus to,
create an aggregate component that is reusable across extract, transform, load (ETL) data pipelines or extract, load, transform (ELT) data pipelines, wherein the aggregate component comprises a plurality of components, wherein the instructions to create the aggregate component comprise instructions to,
detect selection of a set of components for inclusion in the aggregate component, wherein the set of components comprises a first component and second component;
create a first virtual component and connect an output of the first virtual component to an input of the first component;
configure a schema of the first virtual component, wherein the schema of the first virtual component indicates a number of expected data fields from which to obtain input to the aggregate component; and
create a second virtual component and connect an output of the second component to an input of the second virtual component; and
incorporate the aggregate component into a first data pipeline.

16. The apparatus of claim 15,
wherein the first data pipeline comprises a plurality of components,
wherein the instructions executable by the processor to cause the apparatus to detect selection of the set of components comprise instructions executable by the processor to cause the apparatus to detect selection of the set of components from the plurality of components,
and wherein the instructions executable by the processor to cause the apparatus to incorporate the aggregate component into the first data pipeline comprise the instructions executable by the processor to cause the apparatus to replace the set of components in the first data pipeline with the aggregate component.

17. The apparatus of claim 15, wherein the instructions executable by the processor to cause the apparatus to incorporate the aggregate component into the first data pipeline comprise instructions executable by the processor to cause the apparatus to,
based on obtaining a configuration of the aggregate component that comprises an indication of a data source and one or more data fields of the data source, generate a first query to retrieve data from the one or more data fields of the data source; and
map the one or more data fields of the data source to respective ones of the expected data fields,
wherein a number of the one or more data fields matches the number of the expected data fields.

18. The apparatus of claim 17, wherein the instructions executable by the processor to cause the apparatus to generate the first query comprise instructions executable by the processor to cause the apparatus to,
based on a determination that the configuration of the aggregate component indicates all data fields of the data source, generate a query to retrieve data from each data field of the data source; and
based on a determination that the configuration of the aggregate component indicates a subset of data fields of the data source, generate a query that binds each of the subset of data fields to a respective alias and retrieves data from each of the subset of data fields and retrieves data from others of the data fields of the data source without aliases.

19. The apparatus of claim 17, wherein the instructions executable by the processor to cause the apparatus to generate the first query comprise instructions executable by the processor to cause the apparatus to generate a Structured Query Language (SQL) query comprising a SELECT statement.

20. The apparatus of claim 15, further comprising instructions executable by the processor to cause the apparatus to store the aggregate component in a library of data pipeline components for building data pipelines.
